(19) United States
(12) Patent Application Publication
(10) Pub. No.: US 2021/0182304 A1
(43) Pub. Date: Jun. 17, 2021

(54) DISTRIBUTION MANAGEMENT SYSTEM

(71) Applicant: Renewtrak Global Services Pty Ltd, Sydney (AU)

(72) Inventor: Nicholas McMenemy, Cremorne (AU)

(21) Appl. No.: 16/713,158

(22) Filed: Dec. 13, 2019

(51) Int. Cl. G06F 16/25; G06F 16/215; G06F 21/31

(52) U.S. Cl. CPC G06F 16/254; G06F 21/31; G06F 16/215; G06F 16/252

(57) ABSTRACT

A distribution management system and/or non-transitory computer-readable recording medium is provided for storing instructions are stored for executing a method for distribution management. A data loader for a distribution management system is provided. The distribution management system includes a data loader configured to receive input data; process the input data using a validation assessment to produce validated data; and associate the validated data with a plurality of predefined data fields to create a plurality of data structures. An aggregation module is configured to create an aggregated data structure from the plurality of data structures based on at least one predefined data field. An access point is configured to provide access to the aggregated data structure, wherein the access point is accessible to a first user.

### FIELD OF THE INVENTION

The present invention relates to a distribution management system and in particular to distribution management system for managing data structures within a distribution channel. While some embodiments will be described herein with particular reference to that application, it will be appreciated that the invention is not limited to such a field of use, and is applicable in broader contexts.

### BACKGROUND

Any discussion of the prior art throughout the specification should in no way be considered as an admission that such prior art is widely known or forms part of common general knowledge in the field.

Existing systems are not configured for multiple users to engage and access a distribution channel to manage and alter data structures within the channel Nor do they allow users of the distribution channel to engage in parameter or value changes within the data structures to configure the output information to end users.

While attempts have been made to combine existing systems to create a distribution channel that all users can manage and access, some of these systems are only designed to notify end users that a product or a service such as a subscription, warranty or other periodic payment is due. These systems then simply direct the user to contact a third party to progress the transaction in a manner that is manual and external to the system. Other systems may direct the end user to a payment system for transaction closure; however these systems do not allow multiple participants in the channel. Rather, the channel only involves the end user taking an action.

Examples of existing systems which may be used for distribution management include:
Customer Relationship Management (CRM)—Identifies and enables lead generation to engage potential clients.
Supply Chain Management (SCM)—Management of the flow of goods and services from vendor to consumer.
Marketing automation—Sending notifications such as advertising, SMS, emails and other communications to potential and existing clients.

There are, however, inherent technical difficulties in trying to combine such systems while allowing all users to engage in the distribution system. The CRM, SCM and Marketing automation systems contain a high degree of variability when it comes to data. Further, the data belonging to different users within the distribution channel (such as the vendor) also has a highly variable nature, and will be significantly different between users.

Many of these systems, which are considered “state of the art”, manage the distribution channel in combination with manual processes such as spreadsheets, email and phone books to create notifications. For example, while these systems may allow the input of data, it is difficult for a user to receive this data and work with it in an efficient manner in a format which integrates with their own systems. Furthermore, the existing systems are not designed to validate or filter the input data. This means that systems have to process poor quality or error-riddled data which results in increased processing time and dead end channels. Alternatively, the manual processing of the data using, for example, spreadsheets, means that users must manually update or create new rows of data or data structures. Furthermore, these systems are not configured to enable a multitude of users participating in a distribution channel Rather, they focus on one user (such as a vendor) connecting with an end user.

For example, in the context of using these systems for managing scheduled renewal payments notifications may be sent using email. However, these notifications are specific to users such as the vendor, distributor or reseller. Often these notifications instruct the end user to contact their own sales representative, or a third party, rather than enabling the end user to participate in the channel to obtain a closed transaction. In this case, high value renewal payments are managed using manual process but low value renewals are often left to expire as the systems are simply not designed to handle smaller items for the distribution channel. Furthermore, there are a multitude of other difficulties. Manual effort is required in these systems to follow up renewal requests. Chain of command is difficult to orchestrate when a vendor who offers other services outsources the renewal or management of these services to partners, resellers, and/or, distributors who all apply their own margins to the offer and are involved in management of the renewal. They have no way of updating the data to change a parameter or value in such a way that all users of the channel can work with the updated data. Additionally, CRM databases often contain poor contact information for renewal records. Contact information of participants, including partners and customers, is not consistent across the record systems employed by users and requires manual intervention by each user in the channel to identify, update and/or follow up.

### SUMMARY OF THE INVENTION

It is an object of the present invention to overcome or ameliorate at least one of the disadvantages of the prior art, or to provide a useful alternative.

Embodiments of the present invention enable the management of an entire distribution channel. Embodiments provide a specifically designed data loader configured to filter and validate received input data, and create data structures. Also provided is an aggregation module configured to aggregate these data structures to provide to the users of the channel. Embodiments also provide access points to multiple users to manage and update the same aggregated data structure such that it flows seamlessly through the channel, connecting multiple users and offering an entire end to end distribution channel in a single system. The system may be configured to include many technologies such as email subsystems, database engines, payment gateways, browsers, cloud services to provide management of specific data structures which can be constructed for and managed by multiple users each with their own access points. Embodiments are configured to combine multiple input streams to create a consolidated or aggregated set of data that can be shared between all users of the channel. Relevant subsets of the aggregated data can then be operated on by specific users.

In accordance with a first aspect of the invention, there is provided a distribution management system, including:

a data loader, configured to:
receive input data;
process the input data using a validation assessment to produce validated data;
associate the validated data with a plurality of predefined data fields to create a plurality of data structures;

an aggregation module configured to create an aggregated data structure from the plurality of data structures based on at least one predefined data field; and

at least one access point configured to provide access to the aggregated data structure, wherein the at least one access point is accessible to a first user.

Preferably, the system includes a setting module in communication with the aggregation module, the setting module configured to receive input to set at least one parameter from a plurality of updatable data fields associated with at least one data structure from the aggregated data structure. More preferably, the setting module is further configured to update the at least one parameter associated with the at least one data structure from the aggregated data structure based on the received input. The setting module is preferably in communication with a confirmation module, the confirmation module being configured to confirm the received input before the at least one parameter is updated.

In one embodiment, the setting module receives input from a user via a user interface. In another embodiment, the setting module receives input from an external database.

Preferably, the received input from the external database includes predefined functions or restrictions. More preferably, the plurality of updatable data fields are a subset of the plurality of predefined data fields. The updatable data fields preferably include at least one of a: unique identification value, status, price, margin, date, and contact information.

Preferably, the plurality of data structures is a plurality of records.

More preferably, the data loader is configured to output the plurality of data structures to a staging database.

Preferably, the input data includes at least end user information, account details, item details and offer due dates. More preferably, the input data further includes at least one of: distributor information and reseller information.

Preferably, the system includes a second access point configured to provide access to the aggregated data structure, wherein the second access point is accessible to a second user. The system preferably includes a verification module in communication with the at least one access point, configured to perform verification of the first user before providing access to the aggregated data structure.

The verification module is preferably in communication with the second access point and is configured to perform verification of the second user before providing access to the aggregated data structure.

In another embodiment, the system includes a plurality of access points configured to provide access to the aggregated data structure, wherein each one of the plurality of access points is accessible to a respective user of a plurality of users. Preferably, a verification module is in communication with each one of the plurality of access points and is configured to perform verification of the respective user before providing access to the aggregated data structure.

The verification module performs verification using context-based authentication.

Preferably, the validation assessment includes: determining a quality value for the input data; and discarding the input data having a quality value below a predetermined threshold.

More preferably, validation assessment includes at least one of: deduplication, key restructuring, cleansing, format revision, transformation, derivation, aggregation, integration, filtering, splitting, summarisation, correction, reporting and modification.

In accordance with a second aspect of the invention, there is provided a non-transitory computer-readable recording medium storing instructions for executing a method for distribution management, including the steps of:

receiving input data to a data loader;

processing the input data using a validation assessment to produce validated data;

associating the validated data with a plurality of predefined data fields to create a plurality of data structures;

creating an aggregated data structure from the plurality of data structures based on at least one predefined data field; and

providing access, via at least one access point, to the aggregated data structure, wherein the at least one access point is accessible to a first user.

In accordance with a third aspect of the invention, there is provided a data loader for a distribution management system, the data loader being configured to:

receive input data;

process the input data using a validation assessment to produce validated data;

associate the validated data with a plurality of predefined data fields to create a plurality of data structures;

transmit the plurality of data structures to an aggregation module, the aggregation module configured to create an aggregated data structure from the plurality of data structures based on at least one predefined data field.

### BRIEF DESCRIPTION OF THE DRAWINGS

A preferred embodiment of the invention will now be described, by way of example only, with reference to the accompanying drawings in which:

FIG. 1 is a data flow process diagram of the distribution management system according a preferred embodiment;

FIG. 2 is a data flow process diagram of the data loader of FIG. 1;

FIG. 3 is a diagram of an exemplary data structure of FIG. 2;

FIG. 4 is a data flow process diagram of the distribution management system according a further embodiment;

FIG. 5 is a data flow process diagram of the distribution management system according a further embodiment.

FIG. 6 is an exemplary data flow process diagram of the distribution management system according to a preferred embodiment as applied in the context of managing scheduled renewal payments.

FIG. 7 is an exemplary user interface used in the context of FIG. 6, showing an offer notification email to a distributor;

FIG. 8 is an exemplary user interface used in the context of FIG. 6, showing a distributor margin management interface and opportunity configuration interface;

FIG. 9 is an exemplary user interface used in the context of FIG. 6, showing confirmation interface for issue of opportunities to a reseller;

FIG. 10 is an exemplary user interface used in the context of FIG. 6, showing a reseller notification;

FIG. 11 is an exemplary user interface used in the context of FIG. 6, showing a reseller margin management interface;

FIG. 12 is an exemplary user interface used in the context of FIG. 6, showing an end user notification;

FIG. 13 is an exemplary user interface used in the context of FIG. 6, showing an end user portal;

FIG. 14 is an exemplary user interface used in the context of FIG. 6, showing an offer download option interface

FIG. 15 is an exemplary user interface used in the context of FIG. 6, showing a forward offer form;

FIG. 16 is an exemplary user interface used in the context of FIG. 6, showing an end user enquiry form;

FIG. 17 is an exemplary user interface used in the context of FIG. 6, showing a decline form;

FIG. 18 is an exemplary user interface used in the context of FIG. 6, showing a payment options user interface;

FIG. 19 is an exemplary user interface used in the context of FIG. 6, showing a completed transaction interface for the end user.

### DETAILED DESCRIPTION

The preferred embodiment of the invention provides a distribution management system and method that enables management of data structures through a distribution channel by providing access points for users. The preferred embodiment will be described herein in the context of a distribution channel related to scheduled payments such as renewal transactions. However, it will be appreciated that the systems and methods of distribution management can used in a number of applications, including, but not limited to: collecting donations, managing subscriptions or subscription services, license renewals, warranty renewals, collecting membership fees, medical device maintenance, recalls, club or membership fees, sales drive, targeted sales, and hardware refresh and/or upsell.

System Overview

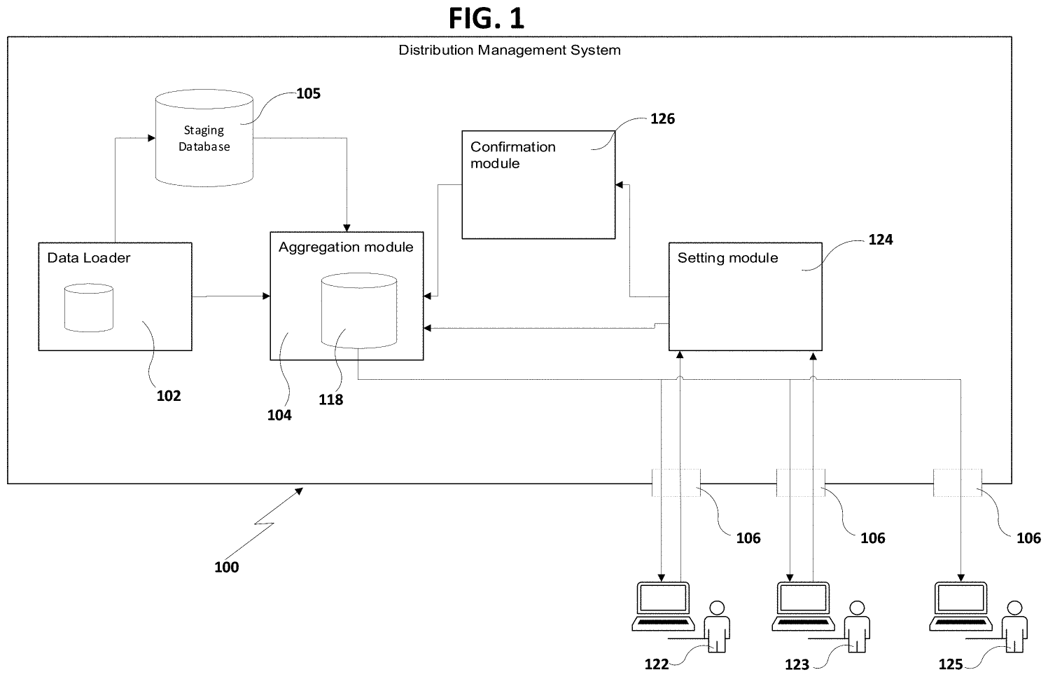

Referring initially to FIG. 1, a preferred embodiment of the invention provides a distribution management system 100. The system includes a data loader 102, an aggregation module 104 and at least one access point 106. The data loader is configured to receive input data 108, process the input data using a validation assessment 110 to produce validated data 112, and associate the validated data with a plurality predefined data fields 114 to create a plurality of data structures 116. The aggregation module 104 is configured to create an aggregated data structure 118 from the plurality of data structures 116 based on at least one predefined data field 120. The access point 106 is configured to provide access to the aggregated data structure 118, wherein the access point is accessible to a first user 122. The system may further include a setting module 124, a confirmation module 126 and a verification module 128.

In overview, the preferred embodiment works by creating data structures that can be prioritised and processed by the data loader 102, while also providing access points 130 for a plurality of users 132 to manage data structures 116. As each user accesses the data, they are able to manipulate and/or operate on the data structures based on functions specific to each user, before passing the data structures onto the next user. In essence, the preferred embodiment thereby provides a distribution channel 134 from data input to an end user 140. The distribution channel 134 may be a single channel. In other embodiments, the single channel may be divided into two or more channels. Alternatively or additionally, in other embodiments the channel may start out as multiple channels and feed into a single channel.

Data Loader

The data loader 102 performs validations and checks for discrepancies within the input data 108. The data loader validates data, filters for quality and discards or fixes unusable or poor quality data.

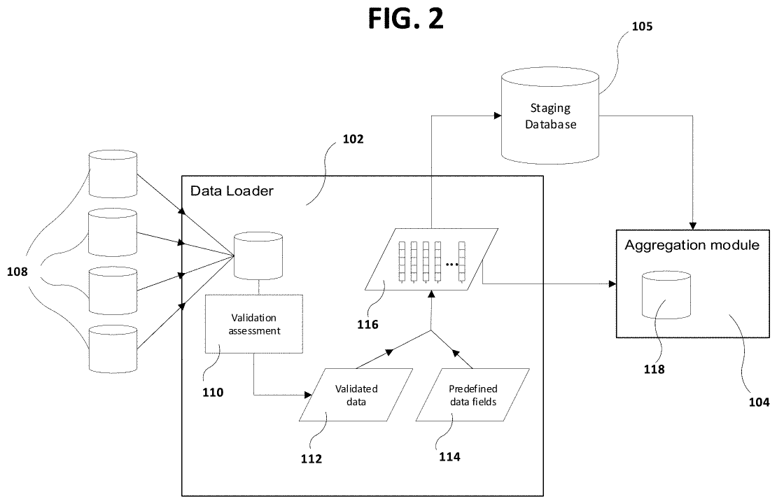

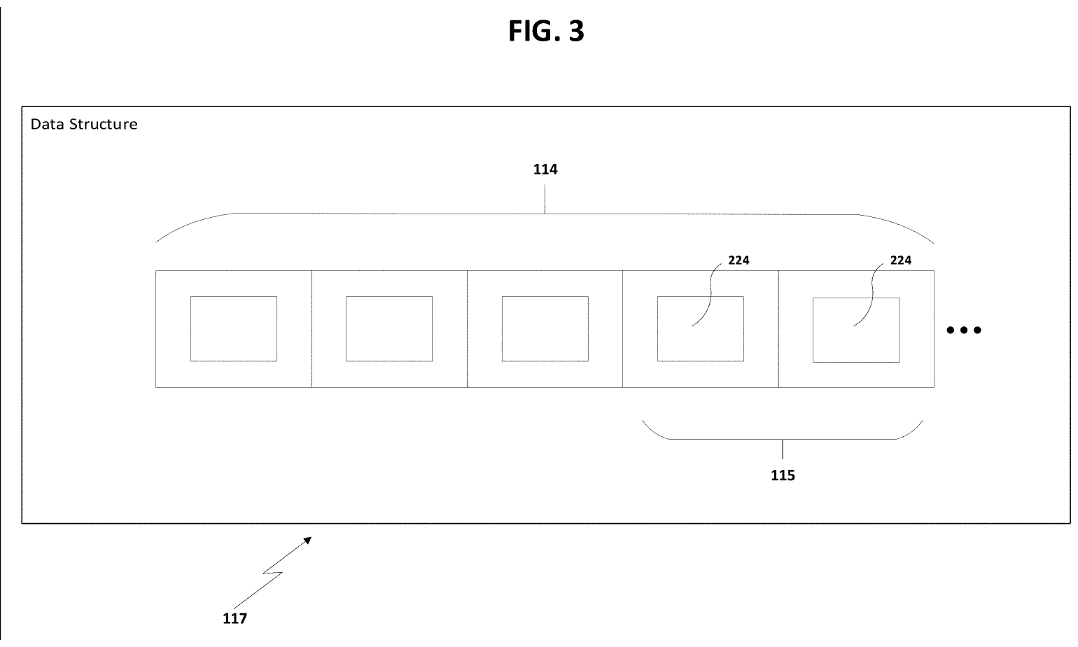

As shown in FIG. 2, input data 108 is fed into the data loader 102. In the preferred embodiment, the input data is ingested through a single data point entry 142. However, the data loader may use multiple data point entries to receive input data. The input data may be any data related to that which is being distributed by the distribution channel. In the preferred embodiment, the input data 108 includes data relating to sales of goods or services such as those relating to a scheduled payment such as renewal or warranty or service dates. However, the input data may relate to other functions. This data may be provided to the data loader in a number of ways. For example, the input data may be in the form of a flat file, csv, spreadsheets, xlsx, xls, or xml file. Alternatively, the data may be provided via an API, or by direct integration with a CRM using SQL, SOQ, REST API, SOAP or other protocol and/or query language. For example, the input data may be provided through integrating with a user's existing system. Alternatively, the input data may be provided by an external database 136 or an external server 138.

In one embodiment, the data loader may be implemented as an Automated Data Ingestion Engine (“ADIE”) 144. As shown in FIG. 2, the data loader automates data ingestion from multiple sources. These sources may include, but are not limited to:
i) Load data 146—This is loaded into a table data structure and digested to its resting destination and cleared out after every load.
ii) Close data 148—This is loaded into a table and digested to its resting destination and cleared out after every load.
iii) External data 150—This supports the load data 146 via a data import/export protocol such as an API or FTP. It is loaded into a table and connected with the load data and cleared out on every load.
iv) Attribute data 152—This supports the load data 146 on data outside of a minimum viable data structure 160. This is loaded into a table and connected with the load data and cleared out on every load.

The data loader 102 then combines, sorts and rinses the data to comply with international standards such as GDPR and ISO by filtering the data 108 over three tiers and applying specific function configurations to generate a data structure 117 in the system 100. Once complete, a report 154 may be generated which reconciles the output with the input and links the information in an anonymised format to a reporting engine 156 for analytics. Analytics may be performed by an analytics module 158 in communication with the data loader.

The input data 108 is processed and filtered by the data loader 102 using a validation assessment 110. The validation assessment determines the validity of the input data, and ensures that sufficient input data exists to create a viable data structure 160. A data structure which has the minimum amount of data to be created is called a Minimum Viable Data Structure (MVDS) 162 or Minimal Viable Record (MVR) 164. It will be appreciated that MVDS and MVR may be used interchangeably herein. As such, the validation assessment 110 ensures that the MVR can be created for each row 168 of input data 108. After the validation assessment, the validated data 112 is then associated with a plurality of predefined data fields 114 to create a plurality of data structures 116. The association may be performed using metadata and analytics of the validated data 112. This metadata may be assigned when the input data is created and/or received 108, or it may be obtained from an external metadata database 166. Alternatively, this information may be assessed and stored when the input data is received 108. In other embodiments, the association may involve matching or aligning data types. In further embodiments, values from the validated data 112 are assigned to the plurality of data fields on a row by row basis.

The Minimum Viable Record 164 is a data structure 117 which contains the necessary fields required to create a record 170 that can be identified within the distribution management system. The data loader applies the validation assessment to the input data to ensure the input data is accurate and complete. For example, in the case where input data relates to scheduled renewal payments, the validation assessment may process the data 172 to determine if a unique account identifier 174 has a valid phone number 176 or email address 178, if the email address 178 matches the domain of the account holder 180, or if an address 182 is within a specified region or jurisdiction.

Validation Assessment

The validation assessment 110 may be performed by the data loader 102, or by a separate module within the data loader. Alternatively, the validation assessment may be performed external to the data loader. In other embodiments, the validation assessment of the input data 108 may be performed by a third party or by a separate system before being fed into the data loader 102.

Input data 108 often includes duplicate entries, contradictory data (such as a value being different for the same item) and may also contain corrupted information such as malformed, incomplete or missing data. For example, when a vendor 184 provides input data, this often includes duplicate orders, data where the price is recorded differently for the same product, abnormal email addresses, and incomplete or missing contact and identification data for a customer. The validation assessment 110 performed by the data loader aligns known data 186 across data tables 188 and discards unusable data while flagging the data which requires remediation.

Once the validation assessment is performed on the input data, this produces validated data 112. The validated data is compiled and output into a staging database 105 which holds the Minimal Viable Record 164. Alternatively, the database may be any intermediate database. The database may be external to the system. For example, in the case where the records or data structures 116 are created for distributing and management of scheduled payments such as renewals, the fields required for the MVR 164 to identify a created record 170 include a user identifier 174 (such as the name of an account owner, a unique number, or the like), contact data 177, goods and services information 175, pricing and margin information 179, due dates 181, notification strategy and procedures, expiry, and timeouts for users 183. However, it will be appreciated that the data fields 114 required for the MVR 164 may include more or less fields depending on the application.

At least part of the validation assessment 110 may include filtering the validated data 112 for quality. This may occur as part of the validation assessment. Alternatively, the quality filtering may occur after the validated data has been output to the staging database 105, and may be effected by a separate module such as a quality filtering module 190. The quality filtering module may be a part of the data loader 102, or may be a separate module in communication with the data loader and the staging database. The quality filtering is performed by determining a quality value 192 of the validated data 112. The quality value 192 may be determined by applying an algorithm 194 that calculates the number of valid data structures with various states of quality. For example, a data structure 117a with an email contact but no phone number may be considered higher quality than a data structure 117b which is missing information required to initiate a notification or transact a renewal offer. In other words, a higher quality data structure includes populated data fields which do not prevent the flow of the distribution channel 134, whereas a lower quality or poor quality data structure is missing information which prevents the distribution channel 134 from performing particular functions. However, it will be appreciated that high quality and low quality may include other relevant factors.

Quality values can be defined as the ratio of usable data to unusable data structures or records. Additionally or alternatively, the quality value 192 may be the ratio of usable data structures with complete information relating to specific data fields, to those with usable though incomplete information relating to the specific data fields.

In the context of contact information, such as that which would be used for a distribution channel for goods and services, missing or corrupted information can be determined for example, where there is no email address 178 associated with an user account identifier 174, where an email address 178 is malformed or distorted, or in the wrong format, where there is an incorrect number of digits in a phone number 176 (that is, where the stored string or value does not match the format of a target value 200), or where delivery or billing addresses 182 are not within the region stored against the data structure.

Poor quality data is determined where there may be enough information to progress through the distribution channel and reach an end user, but the data may contain errors or missing data. For example, where the contact information includes a user email account, the distribution channel can connect with the user, even if there is no phone number or if the billing address does not match the delivery address.

The validation assessment 110 that produces validated data 112 provides strong technical advantages. During testing, it was found that entering data without pre-validation was an unsustainable mechanism for delivery of the data. It resulted in an unstable and unusable system. APIs and external components are only able to contribute to the validations of data types, and so having the data loader within the distribution management system enables full validation to occur. Furthermore, full validation was required for integration with the data structures. Moreover, the workflow variations between the data structures and the access points presented a substantial gap that required fundamental reengineering of these data structures.

Extraction, Transformation and Loading (ETL) of Data

The workflow of the data loader 102 in performing extraction, transformation and loading (ETL) of data is illustrated in FIG. 2. In embodiments of the present invention, the data loader automates the ETL process and encompasses functionalities such as data extraction, data transformation, and loading data pipelines with batch processing.

The process of extraction, transformation and loading of data which is performed by the data loader 102 first requires data to be extracted correctly. The data loader combines data from multiple source systems, each with its own data organisation and format including, but not limited to, relationship databases, non-relationship databases, XML, JSON, CSV files and the like. This allows the system 100 to connect and/or communicate with a number of different systems including various CRM and SCM systems.

After successful extraction, the data 108 is then converted into a single format for standardised processing. The data loader creates a set of data that defines the set of permissible values for the system data requirements. The data loader then confirms whether the data 108 pulled from these sources has the expected values. The validation assessment 110 rejects data if it fails to meet validation requirements. Examples of validation assessments which can be performed by the data loader include one or more of, but are not limited to, the following steps:
Deduplication (normalising): Identifies and removes duplicate data by status.
Key restructuring: Draws key connections from one table to another.
Cleansing: Involves deleting old, incomplete, and duplicate data, to maximize data accuracy. This is done through parsing to remove syntax errors, typos, and fragments of records or data structures.
Format revision: Converts formats in different datasets into one consistent format. Data sets may include, but are not limited to, date/time, gender, phone numbers/email addresses/international addresses and units of measurement.
Derivation: Creates transformation rules that apply to the data.
Aggregation: Gathers and searches data so it can be presented in a summarised report format.
Integration: Reconciles diverse names/values that apply to the same data fields across the data, so that each field has a standard name and definition.
Filtering: Selects specific columns, rows, and fields within a dataset.
Splitting: Splits one column into more than one column.
Summarisation: Creates different metrics by calculating value totals and numbers loaded.
Reporting on rejected records on an “as encountered” basis, to identify what went wrong.
Correcting the source data to conform with the distribution management system data ingestion database requirements.
Modifies data extraction to implement any new logic that is encountered during the load process. This process is more commonly used to add missing exceptions that were not previously part of the validation process.

Once the usability of the data 108 within the system is determined and validated data 112 is produced, the data loader completes several procedures to improve the quality of the validated data 112 it ingests:
Rinse the data 108 to remove any extraneous or erroneous data.
Applies any user specific functionalities.
Checks for data integrity with the data load to ensure that the data 112 was not corrupted in source, or corrupted by ETL, and that no data was dropped in previous stages.
Create preliminary grouped data structures 119 as necessary. For example, this can group data structures 116 by quote number, country, account name, due date and the like.

Once the quality filtering is completed, and the validated data 112 is associated with a plurality of predefined fields 114 to create a plurality of data structures 116, the data loader 102 then outputs the data structures 116 to a staging database 105. This has the added advantages of ensuring GDPR and ISO compliance, as well as enabling the ability to roll back if something goes wrong or if this is required within the system 100. The data loader is also able to generate audit reports for regulatory compliance and diagnose and repair data problems. The data loader then performs incremental loads to target table data structures 202 and executes the relevant procedures on which the data may be transacted. The data loader is then able to transmit data synchronisation and information in an anonymised format to a reporting engine 156 for analytics.

Aggregation Module

The validated data 112 in the staging database 105 is then applied to a live database 204 running in an instance as deployed within a cloud processing platform. Data structures or records which exist in the live database 204 are updated and/or removed based on updated information 206. The updated information 206 is provided by the validation assessment and quality determination performed by the data loader 102. Additionally, data structures 116 may be removed based on external factors. For example, if a data structure for a renewal payment is created, and then an end user pays through another channel (such as in person at an office or via a third party website) the data structure can be closed. Alternatively, new records can be created when new quotes for goods and/or services are generated.

The data structures 116 are used to create an aggregated data structure 118 based on at least one predefined data field 120. For example, this could include a unique identifier or a date. A specific user may define the fields that must be unique per data structure 117. In some embodiments, the data may be aggregated based on the uniqueness of those data structures 116 or based on preliminary grouped data structures 119. The predefined data field may be determined in advance of the system, at the time the input data 108 is received, at the time the data structures 116 are created and/or after the data structures 116 have been transmitted to the staging database 105. In other embodiments, the predefined data field 120 may be selected by user input or predefined functions or procedures. The predefined data field 120 upon which the aggregated data structure 118 is based may be updated at any time, with the update flowing through the distribution channel 134 to be reflected substantially in real time. Alternatively, a number of predefined data fields 121 may be selected based on user input and/or predefined functions or procedures. In further embodiments, the selected predefined data fields 121 may be sorted or ranked based on user input and/or predefined functions or procedures.

The aggregated data structure 118 may be a complex data structure, wherein any type of data can be referenced as a single entity, and yet consists of more than one piece of data. The aggregated data structure 118 may be used to keep all related data together in a way that emphasises the relationship of the data. The aggregated data structure is used to create higher-level structures for a more effective data use. By creating the aggregated data structure 118 from the plurality of data structures 116, this assists in making programs less complicated and easier to understand and maintain, thereby improving the speed and efficiency at which data is processed through the distribution channel 134. In other embodiments, an aggregated data structure 118 may be an aggregate. Alternatively or additionally, the aggregated data structure 118 may be a collection 208. The collection 208 may utilise certain data structures, such as hash tables and binary trees to improve memory and performance characteristics.

As an example of aggregated data structure in the context of a scheduled renewal payment, the staging database 105 may store a number of data structures 116 in the form of records 171, each of which relates to a renewal payment to be paid. If distribution management system 100 is managing distribution of scheduled renewal payments due within the next 90 days, the predefined data field 116 may be the “due date”. Accordingly, based on the “due date” data field, those data structures 116 which have a value of the “due date” data field meeting the requirement of being 90 days or less than 90 days from the present time, can be aggregated into an aggregated data structure 118a which contains a subset of data structures 116a for renewal payments which are due within 90 days.

Users

Once the aggregated data structure 118 is created, information relating to the aggregated data structure is output to the users 132 or participants in the channel.

For example, when the system is used for managing renewals, the system identifies records or data structures for specific quotes within a predefined timeframe and identifies notifications to be output, collating these per user. For example, a predefined timeframe may include, but is not limited to, all items for renewal purchased via a specific distributor, within one quote to one customer, or adjacent items in different quotes belonging to the same customer within a narrow timeframe. Once the quotes and timing are set, a notification is output to the user advising them of their upcoming renewal to process and/or transact.

In the following description, reference will be made to multiple users 132 or multiple participants within the distribution channel. The terms “participant” and “user” may be used interchangeably. In the system, one or more users may access the aggregated data structure through individual access points. In the context of managing data structures relating to distribution of goods and/or services, the terms “vendor user” or “vendor”, “distributor user” or “distributor”, “reseller user” or “reseller”, and “end user” will be used to distinguish the multiple users of the distribution channel. The term “reseller” may also be used interchangeably with the term “partner”. However, it will be appreciated that the users are not limited to roles as a “vendor”, “distributor” or “reseller”. Rather, the terms are intended only to provide an example of different users in the context of a typical distribution channel, and in lieu of using the terms “a first user”, “a second user”, “a third user”, and so on. It will also be appreciated that these terms are not intended to limit the number of users that participate in the distribution channel. For example, the system may include only the end user, any variation of the above described users, or additional users.

In an exemplary embodiment, the distribution channel 134 of the invention may include a vendor user 210 who provides the input data 108, a distributor user 212, a reseller user 214, and an end user 140. A vendor or a vendor user can be any provider of services, goods, products, even if they source these from other vendors.

However, it will be appreciated that longer or shorter channels, with more or less users respectively, may be used. For example, the distributor user and/or the reseller user may not be included in some distribution channels or may be bypassed through the channel. For example, in some embodiments the aggregated data structure may be provided directly to the end user 140. In other embodiments, the data 118 may first be provided to a distributor 212, then to a reseller 214, and then to the end user 140, without manipulation of the aggregated data structure 118 through each step of the channel 134. In other embodiments, the distributor user 212 or reseller user 214 may be omitted from the channel. This may be because no distributor and/or reseller is involved within a particular distribution channel, or they may be bypassed if a predetermined amount of time has passed (that is, a timeout occurs for the user input or participation within the channel). For example, after information is output to a user 212, 214, 140 of the channel, the user is given a predetermined amount of time to either manipulate or update the individual data structures 116b which form part of the created aggregated data structure 118b from their associated access point or confirm the data structures 116b. If they do not update or confirm within this time frame, access to the aggregated data structure 118b is moved onto the next user in the channel.

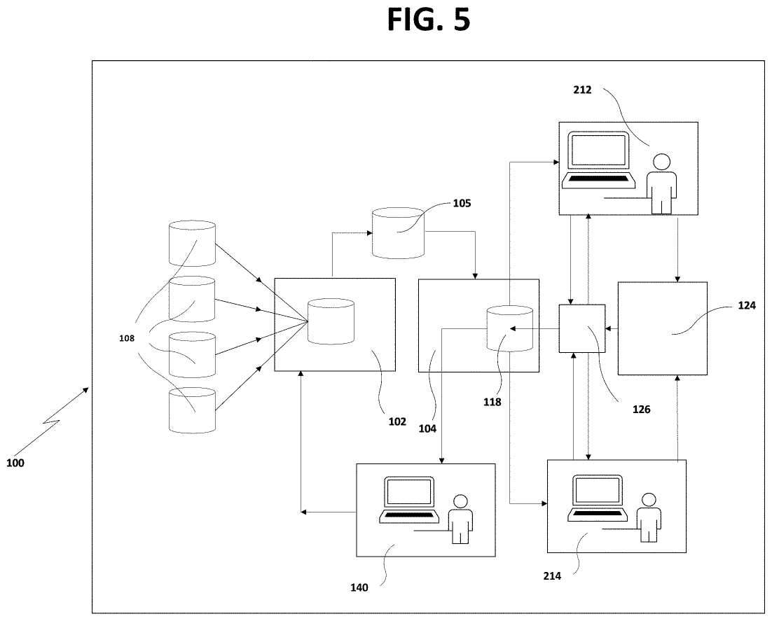

FIG. 5 shows an embodiment in which the above described strategy is applied to the aggregated data structure and how various users can be bypassed. In some instances, a shorter channel with only three or less users may be the normal channel. For example, where a distributor is also a reseller, the channel moves directly from the distributor to the end user. Alternatively, the aggregated data structure may be provided directly to the end user.

Access Points

A first user 122 may access the aggregated data structure 118 though a first access point 107a. The access point provides access to the aggregated data structure 118 for the first user. Alternatively or additionally, the access point 107a may provide access to a setting module 124 in communication with the aggregation module 104. In some embodiments, the system includes a second access point 107b configured to provide access to the aggregated data structure 118, wherein the second access point 107b is accessible to a second user 123. In other embodiments, the system 100 includes a plurality of access points 130 configured to provide access to the aggregated data structure 118 and/or the setting module 124, wherein each one of the plurality of access points 130 is accessible to a respective user of a plurality of users 132. That is, a first access point 107a provides access for a first user 122, a second access point 107b provides access for a second user 123, a third access point 107b provides access for a third user 125, and so on. The level of access provided by each access point may differ depending on the identification of the user. For example, some functionalities such as updating the data structures 116b within the aggregated data structure 118 may be accessed by a distributor and/or reseller, but not by an end user. For example, some users may be provided read access and some users may be providing setting access.

The access point 106 may be generated by the distribution management system after the aggregated data structure 118 is created. For example, it may be in the form of a unique generated access link, provided to the user. The link may include an expiry period. Alternatively, the access point may be provided within the system in the form of a portal. Users may access the aggregated data structure 118 and/or the setting module 124 by logging in to a secure portal 220 using a unique identifier. The unique identifier may include, but is not limited to a password and username, biometric signal or image, or other unique values. The secure portal 220 may be a web portal or a secure client portal. In some cases, multiple users may utilise a single access point. For example, multiple employees from a company representing the distributor user may all have access to the access point provided to the distributor user.

The user 122 is provided an access point 107a to the aggregated data structure. This may be in the form of access via a log in to a portal 220. Alternatively, this may include a notification which provides a secure link, authenticated token or other means of accessing the aggregated data structure. For example, the user may log in to a secure portal which provides access to the aggregated data structure which may involve authentication or verification of the user's identity. In additional embodiments, when using the access point, the aggregated data structure is filtered for processing, such that only a subset of data structures 116a which are part of the aggregated data structure 118 and which are relevant to the user are accessible. For example, the access point 107a for a user 122 may list only data structures which include a specified parameter or value. In other embodiments, all data structures which make up the aggregated data structure are listed.

The access provided by the access point may include, but is not limited to, reading, viewing, setting or updating data structures or parameters within the data structures, and confirming data structures or updates to data structures. Additionally, access may include closing, moving or discarding data structures from the aggregated data structure.

Setting Module

The system further includes a setting module 124 in communication with the aggregation module 104, the setting module is configured to receive input to set at least one parameter from a plurality of updatable data fields 115 associated with at least one data structure 117 from the aggregated data structure 118. In a preferred embodiment, a first access point 106 is provided to a distributor user 122, 212 through which the aggregated data structure can be accessed. The distributor user may then alter or set updatable data fields within each of the data structures which form the aggregated data structure by inputting data into the setting module.

The setting module 124 is configured to receive input 222. The received input may be from a user via a user interface. Alternatively, or additionally, the received input may be built in to the setting module in the form of predefined functions. In other embodiments, the received input 222 may be imported from an external database or an external server.

The parameter 224 refers to a value contained in a variable associated with one of the plurality of predefined data fields 114. Alternatively, the parameter may be another updatable variable in another part of the system. In other embodiments, the parameter may be a variable. The variable may be global or local. In another embodiment, the parameter may refer to an argument used in a subroutine to refer to one of the pieces of data provided as input to the subroutine. In some embodiments, the variables may only be able to store a specified datatype (such as an integer or string). Alternatively, a datatype may be associated only with a current value, allowing a single variable to store anything which may be supported by the relevant programming language. Variables may be automatic or external variables.

Specific parameters required by the MVR 164 will differ depending on the context and the data used by the system. In the context of managing distribution of scheduled renewal payments, the MVR may comprise the following example fields:

| MVRR Field(s) | Description |
|---|---|
| Account Name | The account name of the end user |
| Account Number | The alphanumeric identifier for the account holder |
| Account Country | The country the end user is located in |
| Account Postal Zip Code | The postal code the end user is located in |
| Account Contact First | The first name of the end user contact |
| Name | |
| Account Contact Last | The last name of the end user contact |
| Name | |
| Account Contact Email | The email address of the end user contact |
| Distributor Name | The account name of the distributor |
| Distributor Contact First | The first name of the distributor contact |
| Name | |
| Distributor Contact Last | The last name of the distributor contact |
| Name | |
| Distributor Contact Email | The phone number of the distributor contact |
| Distributor Country | The country the distributor is located in |
| Partner Name | The account name of the partner (if applicable) |
| Partner Contact First | The first name of the partner contact (if applicable) |
| Name | |
| Partner Contact Last Name | The last name of the partner contact (if applicable) |
| Partner Contact Email | The phone number of the partner contact (if applicable) |
| Partner Country | The country the partner is located in (if applicable) |
| Product Name | The title of the product being renewed |
| Product Description | The description of the product being renewed |
| Order/Quote/Contract | The unique grouping title of the order |
| Number | |
| Unit Quantity | The quantity of the product being renewed |
| Unit Price | The price of one unit of the product |
| Serial Number | The unique identifier of the product |
| Previous Service End Date | The date the previous service term started |
| Previous Service Start Date | the date the previous service term ended |
| Current Sku/line item | The SKU or line item of the product being renewed |
| Quote Expiry Date | The day at which the quote is no longer renewable (if applicable) |
| Vendor Contact Email | The phone number of the distributor contact |
| Vendor Contact First Name | The email address of the distributor contact |
| Vendor Contact Last Name | The first name of the distributor contact |
| Distributor Revenue Rate | The margin the distributor makes in percentage terms |
| Distributor Revenue | The margin the distributor makes in dollar terms |
| Amount | |
| Partner Revenue Rate | The margin the partner makes in percentage terms |
| Partner Revenue Amount | The margin the partner makes in dollar terms |
| Product Number | The Grouping number of the products |

However, it will be appreciated that more or less fields may be required by the MVR in the context of managing distribution of scheduled renewal payments. In some embodiments, the MVR 164 may be maintained as separate tables within the databases. Additionally, it will be appreciated that the above table is an example only, and it not intended to limit the number of fields required for the MVR across multiple contexts, nor is it intended to limit the names or descriptions of such fields.

Confirmation Module

The system may further include a confirmation module 126. As shown in FIG. 5, The confirmation module is configured to confirm the received input 222 from the setting module 124 before the at least one parameter 224 is updated. In some embodiments, the confirmation module may be configured to confirm that no updates are being provided to the plurality of updatable data fields 115 associated with at least one data structure 117 from the aggregated data structure 118. Additionally or alternatively, the confirmation module may include predefined functions which prevent specific updates to a specific parameter.

Verification Module

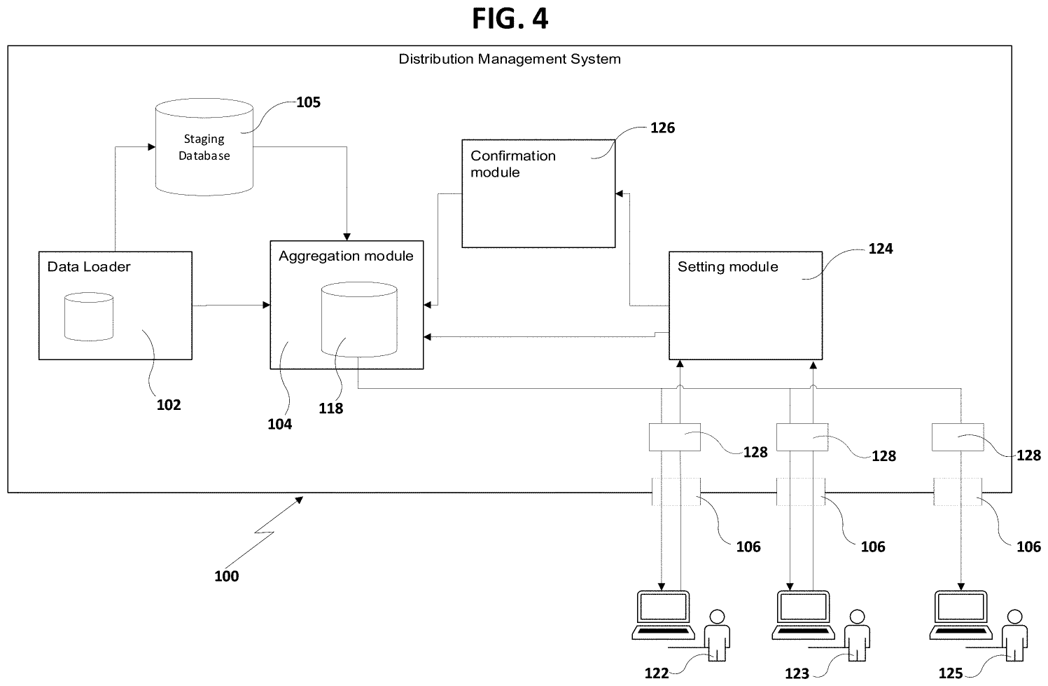

The system may further include a verification module 128, in communication with the access point 106, which is configured to verify identification of the user 132 before providing access to the aggregated data structure 118. As shown in FIG. 4, the verification module 128 may be a part of the access point or it may be separate from the access point. In one embodiment, the verification module is in communication with a plurality of access points, and is configured to verify identification of multiple users before providing access, though the respective access point, to the aggregated data structure. In other embodiments, multiple verification modules may be in communication with multiple access points. The verification module may also be referred to an authentication module, and verification may be referred to as authentication.

The verification module 128 may verify identification of a user through a number of methods. The verification module may use context based authentication. Context based authentication identifies the user and their role in the channel and presents a user interface specific for that role. In other embodiments, the method of verification may include, but is not limited to, provision of a unique identifier (for example a username and password), biometric information, proximity detection, access to a secure link, identification documentation, an authentication token or code, and the like. In yet further embodiments, the verification used can include multiple factor, SMS, authenticator, one time passwords, user and password and/or tokens based on the predefined requirements. The predefined requirements may be set on a per user basis. Once the identification of a user has been verified, the user is provided access to the data structures 116a which form the aggregated data structure 118.

In further embodiments of the system, some access levels may require a higher degree of verification than others. For example, a user that has access to set parameters 224 and update the data structures 116b may require a secure login and an authentication code, whereas a user with read access may only require a secure login. This could include, for example, an end user having read access. However, it will be appreciated that any user may have any relevant level or type of access, as required. For example, an end user may have write access to alter their contact information, change a quantity of an item, or other information.

Application in Renewals

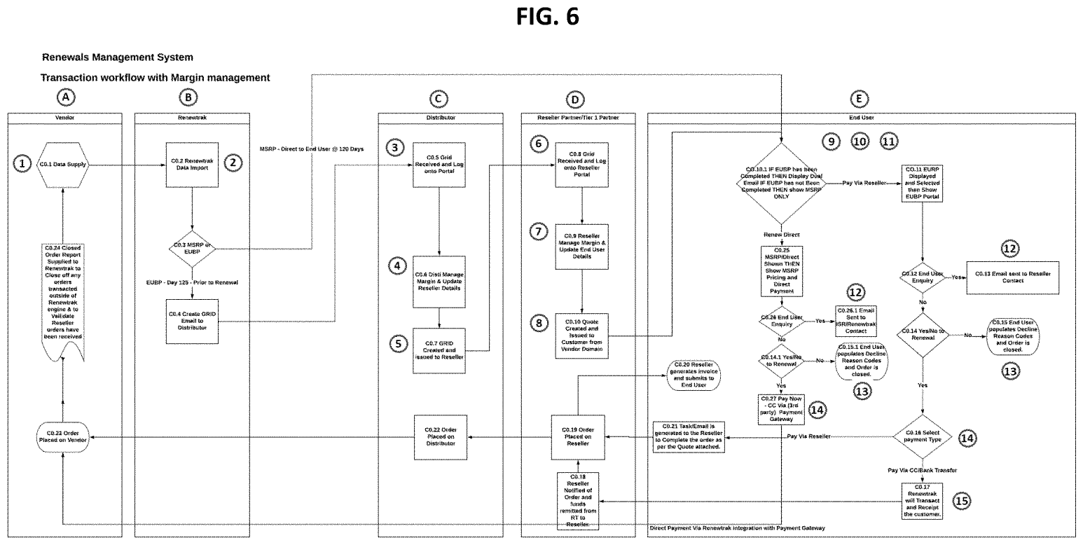

As illustrated in FIG. 6, an embodiment of the invention provides a distribution management system which can be used in the context of managing scheduled renewal payments. In this context, the system can automate processes required to address issues related to manual methods of combining, managing and updating data structures and values within their updatable fields such that multiple users can participate in a single workflow and changes can be applied by each user in the channel. For example, end users can easily view and pay renewals, and distributors or resellers can update parameters such as margins for each renewal item.

The implementation of the invention in this context provides databases in a cloud computing platform (such as, but not limited to Microsoft® Azure) and provide an interface to allow upload or interconnection to a sales database to collect sales data with renewal/order/item due dates. The sales data is then validated to ensure contacts align with customers and/or that the contacts actually exist. The sales data is moved into a database designated “opportunities” which list the quotes, item quantities, values, due dates and associated contact details.

Once this is done, interfaces are provided to the users of the channel. In this case, these users may include a vendor, distributor, and/or reseller. The interface is provided using a web portal which uses context based authentication. Context based authentication identifies the user and their role in the channel and presents the user interface specific for that role. Alternatively, authentication can include multiple factor, SMS, authenticator, one time passwords, user and password and/or tokens based on the vendors requirements. The interface allows the quantities and offer values which are part of the aggregated data structure to be set or updated as needed and allow order verification prior to sending all notifications. Optionally the campaign (or strategy) can be triggered without further alteration. Interfaces are provided to all participants using web servers that connect into the distribution channel.

This embodiment, as applied to distribution and management of renewals, delivers management of each item from vendor to end user within a single application that enables margin and rebate management for all involved participants in the distribution channel, including vendor, distributor, resellers and partners, while engaging the end user.

From the sales data, contact information is automatically collated and potential renewals identified. At data ingestion into the data loader, the available data for the Minimum Viable Record for a renewal is identified and added to tables in a database. The relevant data required for the MVR in the renewals application includes, but is not limited to: Line item/SKU and pricing information, contact information, account information, quote numbers, due dates and offer items. Using the available data, the system correlates the valid entries and determines the due items for processing and creating the records. Email notifications are sent to the end users who are presented the ability to accept, alter or decline the renewal item and/or proceed with payment of the renewal item immediately. This may be completed through a “Renew Now” button which initiates a payment module in which the user can pay the renewal item. Once paid, the renewal item is closed, the closed data is fed back into the system and the data is send back to the Vendor. This enables the system to transact a renewal with a minimum of three clicks being required by the user.

The application of the exemplary embodiment for managing renewal payments is described in the framework of connecting vendors with end users for the purpose of renewing software, hardware, warranty or any other product or service that requires renewal, refresh or migration.

For the purpose of this example, the system will be explained with reference to four key sections of the channel, as shown in FIG. 6, although it will be appreciated that the system is not limited thereto, and it may be divided into more or less sections depending on the setup and varying steps required.

Section A concerns the vendor who initiates a campaign. They provide input data either as a flat file or via an API into the platform at A1, and also allow for closure of the data structures relating to renewal offers once completed by the channel.

Section B manages the ingress of data and the structure of the channel, whether this involves a multiple user channel (including vendor, distributor, reseller and end user), or whether it goes direct to the end user.

Section C details the presentation of the aggregated data structure to the distributor or reseller involved in the channel, which may involve notifications (such as an email) and also enables them to input data to the setting module to adjust a parameter.

Section D provides the same facility as presented to the distributor, however framed for the use of a reseller. Once the data structure representing the renewal offer has been configured and confirmed by the reseller in section D, a notification is sent to the end user who can then access and manage the offer through to payment via a payment module using a variety of different payment types.

A1—Account and Order Information Supplied

The vendor creates a campaign of renewal offers, prepares and uploads input data relating to an account to a portal. This may involve a process internal to the vendor in terms of collating records in disparate systems to collect the data for a Minimum Viable Record or use of an API to automatically provide the information to the data loader.

The MVR requires the data structures to be populated with the information relevant to conducting the renewal offer. This data must include sufficient detail to identify the end user, the product(s) or service(s) being offered, the timing of the offer, the distributor contact information, and the partner and/or reseller contact information. This data may include end user information, distributor information, reseller information, account details, item details and offer due dates. End user information may include a company, contact name, email, phone number, delivery address. Distributor information may include a name and contact. Reseller information may include a name and contact. Account information may include account details. Item information may include an identification number, description, and pricing.

In this example, as each end user may purchase a renewal or item via a different reseller (which may or may not use the same distributor) the record must include, for each end user, the reseller and distributor information.

In some embodiments, depending on the engagement of the participants or users in the channel, the vendor can bypass a participant at any time either by choice or by policy. The vendor can set timeouts that apply if a participant (such as a distributor or reseller) has not processed the order and pass the offer directly to the next participant in the channel. The offer may not include the margins as preferred by the participants or have the customisations suggested by the participants. However the offer can still be made to the end user using parameters set by the vendor or values provided by a third party, such as an external data source containing recommended pricing.

B2—Account and Order Information Ingres

The input data entering the platform is ingested by a data loader, which aligns data across multiple fields, validates and filters the information for quality. The data loader is responsible for identifying contact information relating to the renewal offer and rejecting poor quality data, as well as sorting and collating the data into the structure required to store in a campaign database.

The campaign database may have separate tables for account, contact, inventory identifiers and specific offer items, such as warranty renewal SKU and due dates. Once the input data has been loaded the aggregation module collates the records for upcoming offers and generates opportunities for renewal, aggregating the offers to an aggregated data structure within a desired timeframe as needed.

This aggregation is essential to prevent many single item offers being made to an end user, and to ensure only one renewal offer containing all items is provided. Once the data load has been completed, a predefined strategy can be triggered by the vendor to notify the distributors (or end users directly) of upcoming subscription offers. For example, the predefined strategy may include sending notifications for renewals due within 120 days, 90, days, 60 days and the like.

Each distributor will receive an automated email notification advising them of the renewal offers to be renewed through the resellers.

C3—Offer Notification Received by Distributor

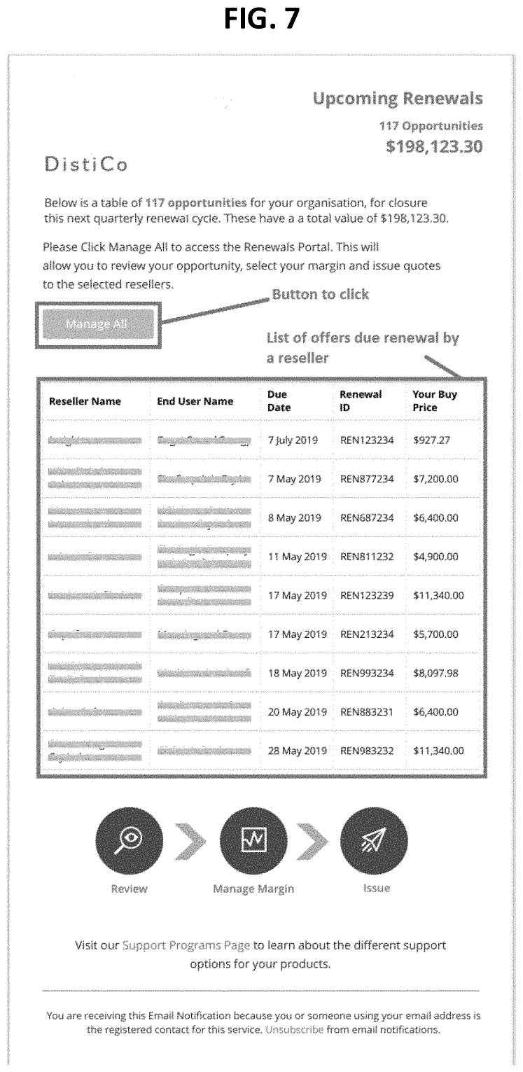

As shown in FIG. 7, a notification is sent to the distributors which lists upcoming notifications and provides an access point. Distributors can click “Manage All” to access their renewal portal via an authentication token to verify their identify, or by logging into the portal using other authentication procedures.

The distributor notification contains the aggregated data structure which lists the offers in the campaign database that are to be processed by a reseller in the delivery chain. A vendor may also choose to send direct renewal notifications to a reseller or an end user directly where the distribution chain does not involve a distributor, partner, and/or reseller.

Distributors are prompted to log in to the portal provided for their access which authenticates them and provides access to the management user interface. When using the link provided in the email, the specific renewal opportunities identified in the email are filtered for processing. When logging in from the distributor login page directly all opportunities are listed. This filtering can be reset by the user. The distributor portal lists all opportunities (offers/renewals) that are due through them, and indicates the correct reseller that the opportunity was sourced through. This will usually be the original seller of the service/product to the end user. The distributor can review all the upcoming opportunities and offers, alter specific parameters, such as the margins they set, for each offer, update information related to the resellers and end users (such as contact information), alter the items offered, change the quantity and approve or confirm the renewal offers to be sent to the reseller. Distributors can also close offers or move offers to alternative resellers where required. These changes are performed in the opportunities database deployed in the cloud server.

The portal is implemented in this example as a single web page with context-based authentication. The views presented in the portal are configured on the authorities granted to each user based on their role. The relevant fields in the opportunities database are presented in the portal and may be modified based on the role of the user (that is, distributor, reseller or end user). As the portal is web based in this example, it can be accessed from anywhere and may additionally be used on kiosk displays, for example within a sales office, or on company and personal computing devices such as PCs, tablets and smartphones.

C4—Distributor Margin Management

Once in the portal the distributor is able to view an aggregated data structure which provides a summary of renewal offers for a specific vendor and a date range where they are able to view more details via Snapshot or Manage Opportunities links.

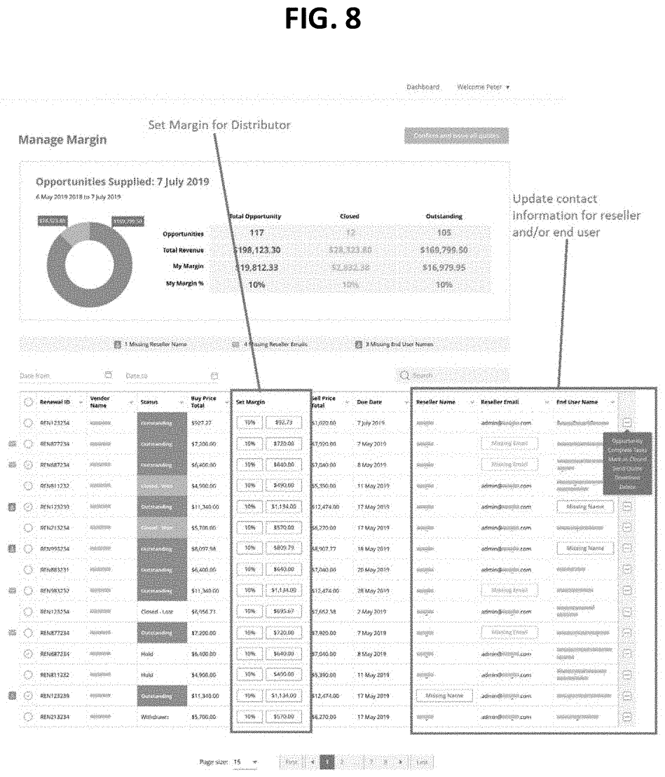

As shown in FIG. 8, the user interface lists the renewal offers which are due and allows the distributor to set or update the margin parameter for their component of the sale for each opportunity or offer, review the aggregated summary and remediate any missing information.

The user interface also presents a summary of the distributor's opportunities for the indicated timeframe to update the information required to process the offers. The user interface allows the distributor to set margins on these opportunities individually or in total. That is, the margin parameter could be updated individually for each renewal offer or for multiple renewal offers all at once. Distributors can update the reseller contact details to allow them to proactively issue a quote to the reseller. The user interface also allows several actions to be undertaken:
Set Distributor Margin on each sale, offer, renewal or opportunity to be presented to the reseller;
Approve/confirm all distributor margins set in the user interface;
Issue quotes (via action button) which will activate an issue quote function and promote the user to the confirmation screen;
Close quotes (via action button) which will close the quote off and prevent it from being issued further;
Export (via action button) which will allow the user to export the quote to XLS, or any other appropriate format; and
Place quote on hold (bottom bar) which will change the quote status to hold, thereby preventing a quote being issued automatically by the renewals management system.

Once the margin management and order configuration is completed, the distributor commits the notification by clicking on the “Confirm and issue all Quotes” button which uses the confirmation module to confirm the updates and trigger all selected notifications to the reseller/partner engaged in the channel.

C5—Verification to Commit Changes

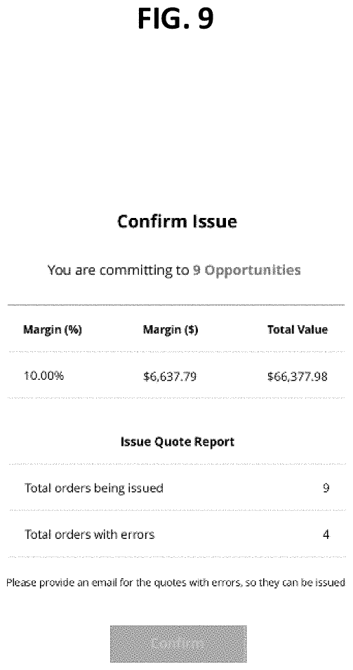

To ensure data structures are not updated with incorrect data, the user interface provides a page to confirm or approve the information submitted as shown in FIG. 9.

Only once the confirmation is provided by the distributor using the interface are the data structures for the associated records updated. Then the automated functionality of the system is enabled to send the designated notifications to the reseller associated with the offers which have been set into an “issued” state by the distributor. Notifications without a valid contact email are not issued.

These notifications may be sent out immediately or on a predefined schedule which determines when particular offers are due, based on configurable windows, in advance to provide notice so the reseller has sufficient time to process the offers to the end users. Such configurable windows may be, for example, 125 days, 95 days, 60 days and the like.

D6—Offer Notification Issued to Resellers

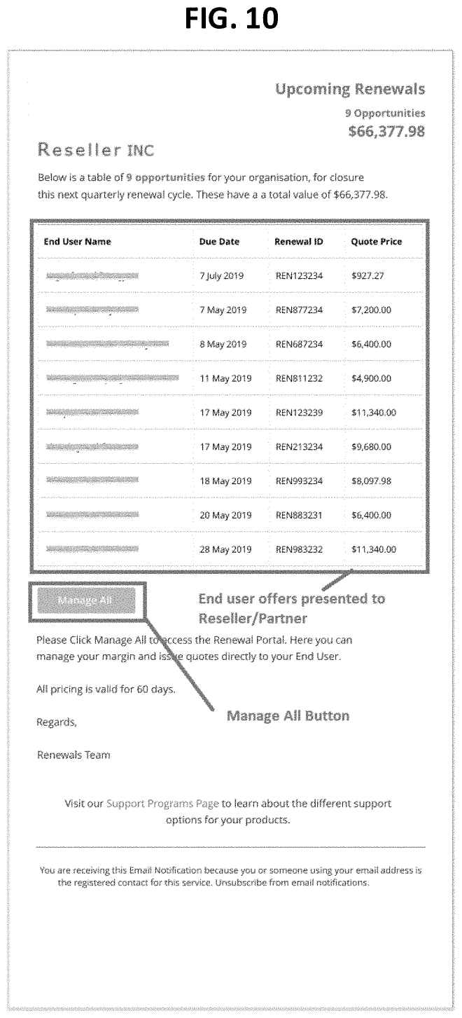

Referring now to FIG. 10, once the distributor has confirmed the upcoming offers each reseller managed by the distributor is then issued a notification email containing an reseller access point. The reseller can see a list of all their renewal opportunities which are listed by an end user contact (for example, company, contact or personal name) The reseller can click “Manage All” to redirect to the portal, and permit access to the aggregated data structure representing the renewal offers confirmed by the distributor.

While this notification is similar to the notification issued in C3, it must be noted that the data source for this form is the individual end user opportunities being offered, and as such only provides those data structure that relate to this reseller.

Resellers are prompted to log into the portal either by using an authenticated token or tokenised link from the email or by other authentication means. As for the distributor, the portal will be filtered based on the method of access (that is, via the link or via direct login to the portal). However, this aggregated data structure shows only the upcoming renewals for that reseller only, with the list showing the end users opportunities. The filter can be reset once logged into the portal. The reseller can update the offers being made, set margin parameters, alter the data structures included, change the quantities, and approve the orders for sending to the end users. The reseller can also close offers where required. These changes are performed in the opportunities database deployed in the cloud server.

D7—Reseller Margin Management and Configuration

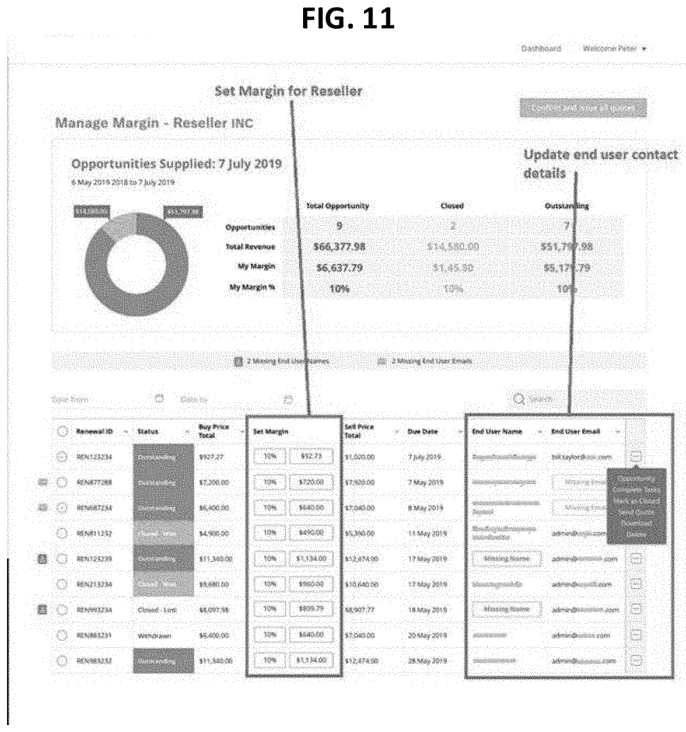

On entering the portal via an access point, for example by clicking a link in the email or by logging in directly, the reseller is presented with their margin management and configuration user interface, as shown in FIG. 11. This will present the offers pending to individual end users through the reseller, rather than the full aggregate of offers pending a reseller.

The user interface provides a summary of the reseller's opportunities or offers for the indicated timeframe. These may be categorized as total renewal opportunities, closed renewal opportunities and remaining renewal opportunities. The user interface allows the reseller to set margins on these opportunities individually or in total. Resellers can update the end user information (such as contact details) to allow them to proactively issue a quote to the end user. The user interface allows several actions to be undertaken:
Upload Reseller Details & Logo for Co-Branding of Quote;
Set Reseller Margin (Red for action—Green for Updated);
Approve All Reseller Margins;
Issue Quotes (Via Action Button)—this option sends a notification to a selected end user directly;
Close Quotes (Via Action Button);
Export to Excel (Via Action Button); and
Place Quote on Hold (Bottom Bar).

Once the margin management and order configuration is completed, the distributor confirms the notification by clicking on the “Confirm and issue all Quotes” button which opens a pane in the user interface to confirm the entered data via the confirmation module.

D8—Account and Order Information Supplied

As was offered to the distributor in C5, a confirmation window (FIG. 9) is presented to the reseller to confirm/approve the data entered before altering the data structures within the system. Once the data has been confirmed, the renewals system will send notifications to the end users based on the predefined notification strategy.

E9—End User Notification Received

Once a campaign is confirmed by the reseller, or an email is triggered by the vendor, the end users receive offer notifications with an access point.

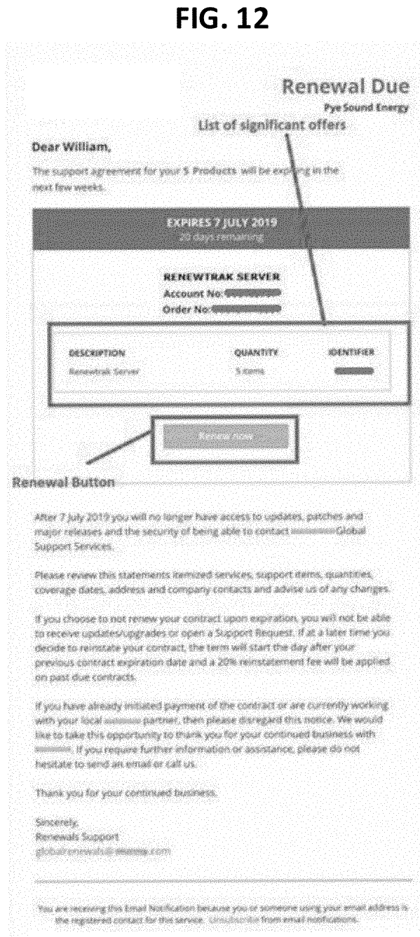

These offers may include one or more items to renew, which may be of the same or different product inventory types. As shown in FIG. 12, an end user notification is sent to the subscriber of the service, warranty, or other product being offered by the vendor. The notification must show the account details of the end user, and list the inventory items being offered for renewal or sale.

The notification contains links to relevant information relating to the offer, such as the privacy policy, terms and conditions of the sale and may also link to the vendor's product information pages. By clicking on the access point represented by the “Renew Now” button, the end user is granted access to a portal by using an authentication token generated by the system to configure, decline or accept an offer.

End user notifications only contain information pertaining to their own renewals. They are provided an authentication token via a button embedded in the email that directly logs the end user into the portal for reviewing and performing the transaction. The end user can review the items listed, delete items no longer required, decline the offer, request support through the enquiry forms, accept the offer and submit payment using credit card, PayPal®, bank order, purchase order or any other payment methods supported by the system depending on policy and region. The changes are set in the opportunity database. The end user can also redirect the notification to another end user, for example, in situations where they are not authorised to transact the offer or have changed roles.

If no configuration of the order is required by the end user, a renewal, subscription or offer can be paid for using a minimum 3 clicks:
Renew Now button in the notification.
Buy Now button in the portal to access the payment screen.
After entering payment details, clicking buy now.

In some embodiments, the system may be configured to pay the offer in less than three clicks, by utilising a one-click purchase at the “Buy Now” stage.

E10—End User Offer Configuration Portal

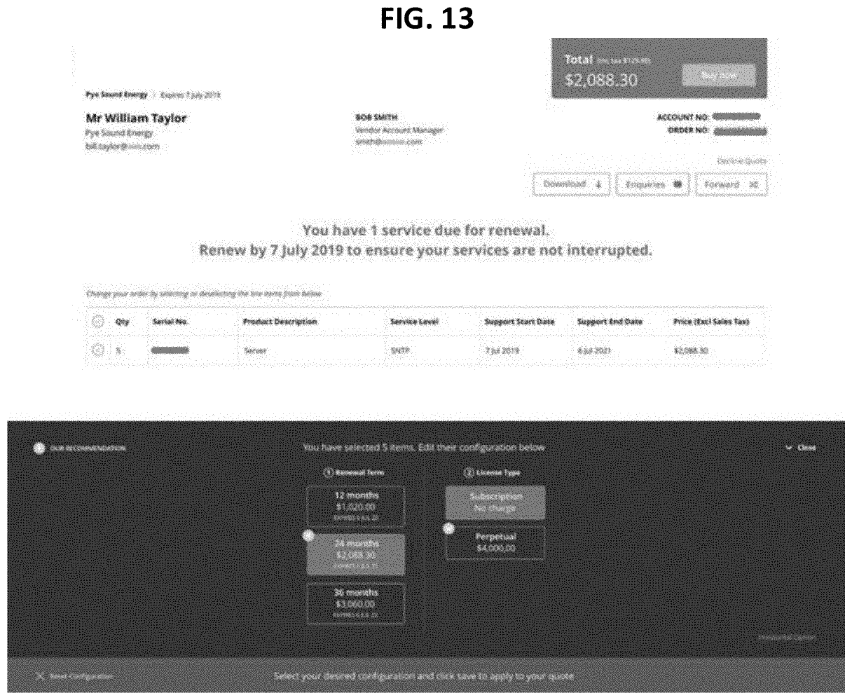

On clicking “Renew Now” in a notification email, the end user is directed to a portal where they can transact the offer. As shown in FIG. 13, the portal presents information specific to the end user. In this example, the end user is presented with a renewal and the ability to configure parameters of the offer, such as the term, license type, alternative products or inventory items offered by the vendor.

The system may also present alternative offers such as hardware refresh, replacement of products, selecting alternative inventory items from the vendor. The user interface provides a summary of the items, the delineated costs and total costs. The user interface informs the end user of their details, the order details, sales agent & reseller details. The user interface then allows several actions to be undertaken:
Select the items to configure or select all.
Select a new term length via the pop up configurator. This will also show various calculations related to the configuration, such as savings over a standard 12 month term.
Select a new product line or service depending on the configuration of a campaign by the vendor.
Adding, removing or replacing items in the offer as allowed by the vendor.
Trigger an enquiry to the sales team via a form.
Redirect the quote to another contact using a form.
Download the quote in spreadsheet or portable document formats.
Decline this quote and provide reasons using a form which provides sample reasons and/or a free text field.
Proceed to payment method by clicking Pay Now′ or ‘Buy Now’.

E11—User Response Capture Forms

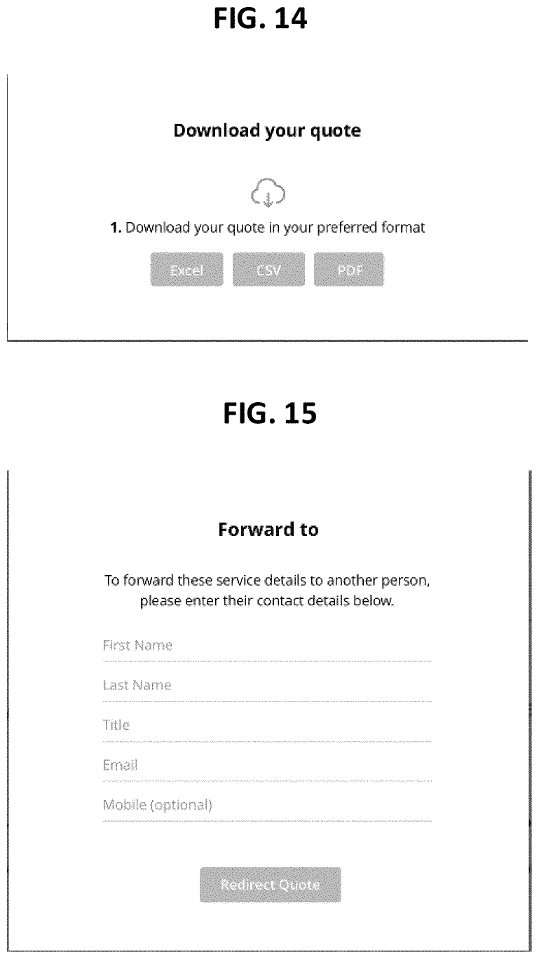

The end user portal provides the end user with the ability to download the quoted offer in spreadsheet and portable document formats, and also to upload modified spreadsheets and/or purchase orders to the portal to be issued to the reseller and/or vendor for processing (FIG. 14Error! Reference source not found.).

If the end user is not authorised to transact the offer within the organisation by which they are employed, the option is available to forward the entire offer to another recipient (FIG. 15). This creates a new notification email with authentication token to the new recipient, who will be engaged by the email as presented in E9. Further levels of verification may be required at this stage to ensure that the forwarded recipient is an authorised recipient.

E12—Enquiry Form

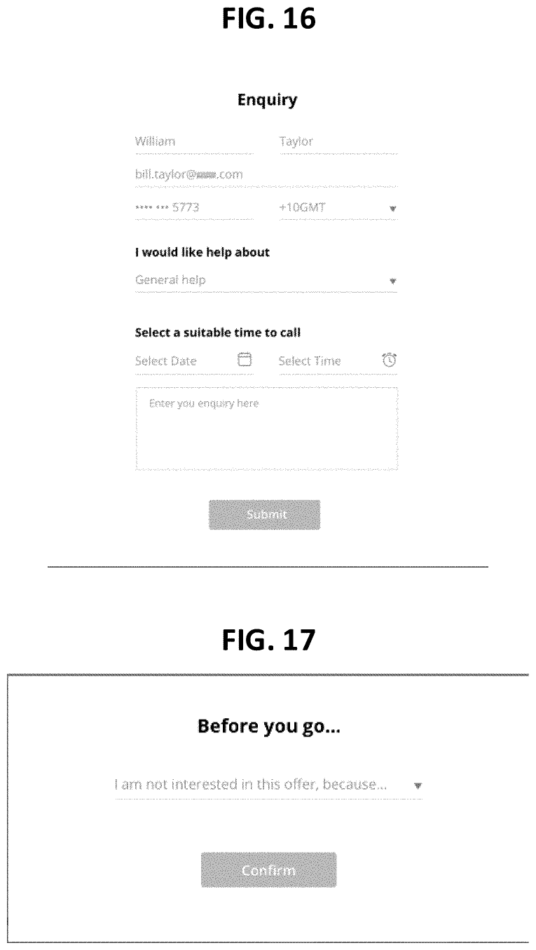

As shown in FIG. 16, the end user can also submit an enquiry which is provided directly to the relevant participant in the channel for action.

E13—End User Populated Decline Reason

As shown in FIG. 17, in order to create more effective campaigns, end users are afforded the opportunity to input a decline reason which can be fed back to the vendor or any other user in the channel. To capture this information a form is used which presents predefined options for the end user to select or may allow free text entry. The data collected may be sent to an analytics engine and/or the relevant user for action.

E14—Account and Order Information Supplied

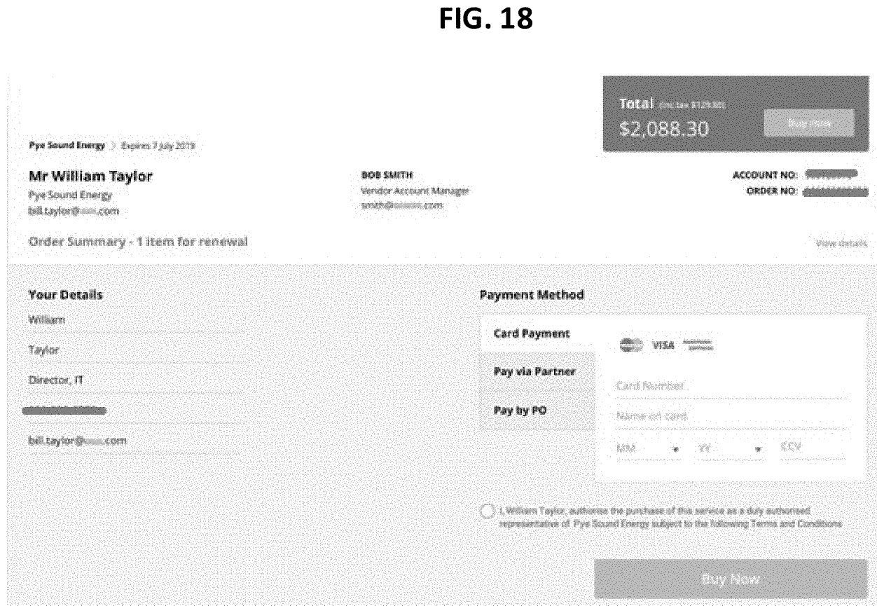

On selecting “Buy Now” the end user is presented options for payment (FIG. 18), including credit card, purchase order and any other specific options provided by the campaign. The payment is processed via a payment module via the selected payment means.

Payment Means Include:
Credit card: Credit card payments are to be processed using a payment gateway or similar technology. Once payment has cleared, an order email will be submitted to the incumbent distributor. A notification email will be sent to the incumbent reseller indicating that this customer has renewed and what margin rebate will be made available to them; and this will close off the offer or renewal with status “Renewed”.
Reseller: An end user accepts the quote and may indicate that they will pay via the reseller. The reseller will send an invoice to the end user directly to be paid. Once payment has cleared, an order email will be submitted to the incumbent distributor. A notification email will be sent to the incumbent reseller indicating that this customer has renewed and what margin rebate will be made available to them. This will close off the offer or renewal with status “Renewed”.
Purchase order: The end user has accepted the quote and may indicate that they will pay via a purchase order. The end user downloads the quote, creates a purchase order and uploads the purchase order back to the portal, and then accepts the terms and conditions. A notification email with the purchase order will be sent to the incumbent reseller indicating that this customer has renewed and what margin rebate will be made available to them. This will close off the offer or renewal with status indicated that it has been renewed via a particular company. This may include the status format “Renewed via [Company Name]”, wherein the “company name” may be any third part or company name.

E15—Account and Order Information Supplied

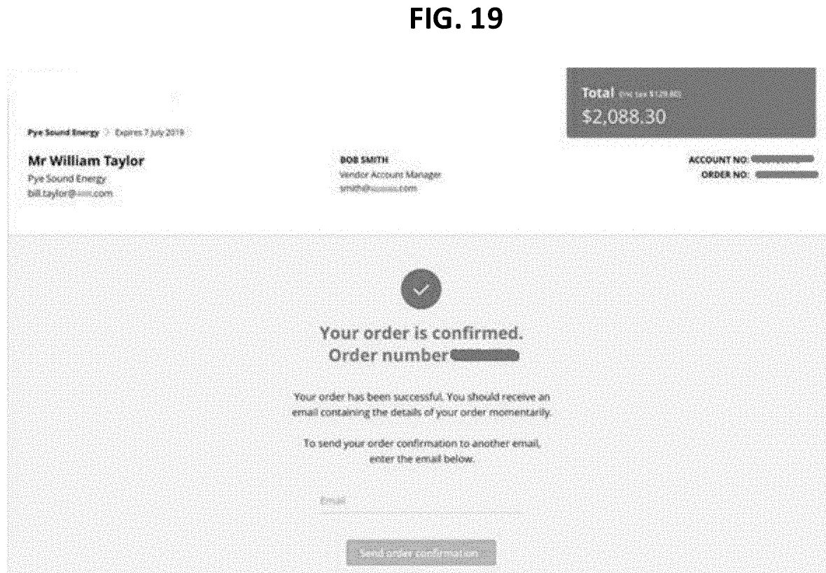

Once an order has been submitted and paid for using the selected options, the user interface presents a confirmation screen with a transaction confirmation number (FIG. 19). For immediate payments the order is processed and closed back to all participants. For alternative payment processes such as purchase order the order remains open until the payment method has been closed by the relevant participant. On completion of the transaction, regardless of configuration changes by each party the relevant percentage margins are returned to the users in the channel

Order Closure:

Where a data structure requires closure, such as on completion of an offer where an end user has either declined or transacted the offer, the opportunities database is updated and closure information is sent back through the channel to the participants. This can be done in a number of ways:
Automated: API connections to the SCM, CRM or other systems can be used to directly update the records for the users with the closure status and values paid.
Manually via email: Once an order is closed the participants are sent an email that includes the closure status of the offer. This is usually performed along with one or more of the other methods.
Via closure loop: The closure information can be provided in reports that are sent back to the vendor at the end of the billing cycle or at specified intervals for processing, as flat files, spreadsheets or other human readable formats.

Discussion of Advantages

By utilising specific techniques required to manage configuration of the data structures by all users of the distribution channel, the management system provides a number of distinct technical advantages over existing systems.

Input data provided as a flat file containing the MVR data fields for each data structure are transformed into a multi-faceted data source which is able to align this data with pre-existing data from other sources for validation. The input data is validated and filtered for quality using a unique process applied by the data loader, which enables the large amount of data to be transformed into high quality data before attempting to process it, creating faster processing efficiencies and reducing errors. The input data is then also arranged into a plurality of data structures which provides improved storage and access. This has technical advantages in creating the aggregated data structure from the plurality of data structures.

Access points are provided for each user, enabling multiple users to participate in the same channel. Users can update and set parameters within a data structure which can then be passed onto the next user in the channel Thereby enabling users to work on the same aggregated data structure. The system works in real time, such that updates to the data structures and additional input data can be processed substantially immediately.

Additionally, there are also advantages to the system in the context of a renewals application. For example, items sold on different occasions may be collated and aligned allowing contract, quote, order, contact, pricing, expiry and information to be validated by the data loader and provided to the vendor/distributor/reseller in alternative formats. Items may be collated and identified for validation by the vendor, distributor and/or reseller. Pricing parameters and information from the raw input data may be aligned and confirmed against alternative data sources provided by the vendor. Data structures in the form of renewal offers are able to be identified from the data source and automation applied to the data set to send the offers to users once key parameters are identified in terms of items ordered, account holder, due dates and margin information.

Further, as the data exists in real time insights can be drawn from the live information and presented in dashboards as KPIs relevant to each participant in the channel, as quantity or values. In the below examples, # represents a count by contract, S represents a count by total revenue:
Total Renewals Due (#)
Total Renewals Due ($)
Total Renewed (#)
Total Renewed ($)
Total Declined (#)
Total Declined ($)
Total Renewal % (#)
Total Renewal % ($)
Renewed Average Order Value (AOV) ($)
In Quarter Renewal Rate (IQRR) % (#)
In Quarter Renewal Rate (IQRR) % ($)

The software also allows a single individual to manage a larger set of data structures through automation. It also enables bulk update of parameters such as margins, setting a foreign currency rate and track in real time where the renewal or offer is up to in the workflow.

### CONCLUSIONS AND INTERPRETATION

Reference throughout this specification to “one embodiment”, “some embodiments” or “an embodiment” means that a particular feature, structure or characteristic described in connection with the embodiment is included in at least one embodiment of the present disclosure. Thus, appearances of the phrases “in one embodiment”, “in some embodiments” or “in an embodiment” in various places throughout this specification are not necessarily all referring to the same embodiment. Furthermore, the particular features, structures or characteristics may be combined in any suitable manner, as would be apparent to one of ordinary skill in the art from this disclosure, in one or more embodiments.

Unless specifically stated otherwise, as apparent from the following discussions, it is appreciated that throughout the specification discussions utilizing terms such as “processing,” “computing,” “calculating,” “determining”, “analyzing” or the like, refer to the action and/or processes of a computer or computing system, or similar electronic computing device, that manipulate and/or transform data represented as physical, such as electronic, quantities into other data similarly represented as physical quantities.

The term “module” as used herein refers to any known or later developed hardware, software, firmware, artificial intelligence, fuzzy logic, or combination of hardware and software that is capable of performing the functionality associated with that element.

In a similar manner, the term “controller” or “processor” may refer to any device or portion of a device that processes electronic data, e.g., from registers and/or memory to transform that electronic data into other electronic data that, e.g., may be stored in registers and/or memory. A “computer” or a “computing machine” or a “computing platform” may include one or more processors.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The methodologies described herein are, in one embodiment, performable by one or more processors that accept computer-readable (also called machine-readable) code containing a set of instructions that when executed by one or more of the processors carry out at least one of the methods described herein. Any processor capable of executing a set of instructions (sequential or otherwise) that specify actions to be taken are included. Thus, one example is a typical processing system that includes one or more processors. Each processor may include one or more of a CPU, a graphics processing unit, and a programmable DSP unit. The processing system further may include a memory subsystem including main RAM and/or a static RAM, and/or ROM. A bus subsystem may be included for communicating between the components. The processing system further may be a distributed processing system with processors coupled by a network. If the processing system requires a display, such a display may be included, e.g., a liquid crystal display (LCD) or a cathode ray tube (CRT) display. If manual data entry is required, the processing system also includes an input device such as one or more of an alphanumeric input unit such as a keyboard, a pointing control device such as a mouse, and so forth. The term memory unit as used herein, if clear from the context and unless explicitly stated otherwise, also encompasses a storage system such as a disk drive unit. The processing system in some configurations may include a sound output device, and a network interface device. The memory subsystem thus includes a computer-readable carrier medium that carries computer-readable code (e.g., software) including a set of instructions to cause performing, when executed by one or more processors, one of more of the methods described herein. Note that when the method includes several elements, e.g., several steps, no ordering of such elements is implied, unless specifically stated. The software may reside in the hard disk, or may also reside, completely or at least partially, within the RAM and/or within the processor during execution thereof by the computer system. Thus, the memory and the processor also constitute computer-readable carrier medium carrying computer-readable code.

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

In the claims below and the description herein, any one of the terms includes, including, comprising, comprised of or which comprises is an open term that means including at least the elements/features that follow, but not excluding others. Thus, the term comprising, when used in the claims, should not be interpreted as being limitative to the means or elements or steps listed thereafter. For example, the scope of the expression a system including A and B should not be limited to systems consisting only of elements A and B. Any one of the terms including or which includes or that includes as used herein is also an open term that also means including at least the elements/features that follow the term, but not excluding others. Thus, including is synonymous with and means comprising.

It should be appreciated that in the above description of exemplary embodiments of the disclosure, various features of the disclosure are sometimes grouped together in a single embodiment, Fig., or description thereof for the purpose of streamlining the disclosure and aiding in the understanding of one or more of the various inventive aspects. This method of disclosure, however, is not to be interpreted as reflecting an intention that the claims require more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this disclosure.

Furthermore, while some embodiments described herein include some but not other features included in other embodiments, combinations of features of different embodiments are meant to be within the scope of the disclosure, and form different embodiments, as would be understood by those skilled in the art. For example, in the following claims, any of the claimed embodiments can be used in any combination.

In the description provided herein, numerous specific details are set forth. However, it is understood that embodiments of the disclosure may be practiced without these specific details. In other instances, well-known methods, structures and techniques have not been shown in detail in order not to obscure an understanding of this description.

Thus, while there has been described what are believed to be the preferred embodiments of the disclosure, those skilled in the art will recognize that other and further modifications may be made thereto without departing from the spirit of the disclosure, and it is intended to claim all such changes and modifications as fall within the scope of the disclosure. For example, any formulas given above are merely representative of procedures that may be used. Functionality may be added or deleted from the block diagrams and operations may be interchanged among functional blocks. Steps may be added or deleted to methods described within the scope of the present disclosure.

1. A distribution management system, comprising:
a data loader, configured to:
receive input data;
process the input data using a validation assessment to produce validated data;
associate the validated data with a plurality of predefined data fields to create a plurality of data structures;
an aggregation module configured to create an aggregated data structure from the plurality of data structures based on at least one predefined data field; and
at least one access point configured to provide access to the aggregated data structure, wherein the at least one access point is accessible to a first user.

2. A distribution management system according to claim 1, wherein the system includes a setting module in communication with the aggregation module, the setting module configured to receive input to set at least one parameter from a plurality of updatable data fields associated with at least one data structure from the aggregated data structure.

3. A distribution management system according to claim 2, wherein the setting module is further configured to update the at least one parameter associated with the at least one data structure from the aggregated data structure based on the received input.

4. A distribution management system according to claim 3, wherein the setting module is in communication with a confirmation module, the confirmation module being configured to confirm the received input before the at least one parameter is updated.

5. A distribution management system according to claim 2, wherein the setting module receives input from a user via a user interface.

6. A distribution management system according to claim 2, wherein the setting module receives input from an external database.

7. A distribution management system according to claim 6, wherein the received input from the external database includes predefined functions or restrictions.

8. A distribution management system according to claim 2, wherein the plurality of updatable data fields are a subset of the plurality of predefined data fields.

9. A distribution management system according to claim 2, wherein the updatable data fields include at least one of a: unique identification value, status, price, margin, date, and contact information.

10. A distribution management system according to claim 1, wherein the plurality of data structures are a plurality of records.

11. A distribution management system according to claim 1, wherein the data loader is further configured to output the plurality of data structures to a staging database.

12. A distribution management system according to claim 1, wherein the input data includes at least end user information, account details, item details and offer due dates.

13. A distribution management system according to claim 12, wherein the input data further includes at least one of: distributor information and reseller information.

14. A distribution management system according to claim 1, wherein the system includes a verification module in communication with the at least one access point, configured to perform verification of the first user before providing access to the aggregated data structure.

15. A distribution management system according to claim 1, wherein the system includes a plurality of access points configured to provide access to the aggregated data structure, wherein each one of the plurality of access points is accessible to a respective user of a plurality of users.

16. A distribution management system according to claim 14, wherein the verification module performs verification using context-based authentication.

17. A distribution management system according to claim 1, wherein the validation assessment includes:
determining a quality value for the input data; and
discarding the input data having a quality value below a predetermined threshold.

18. A distribution management system according to claim 1, wherein the validation assessment includes at least one of: deduplication, key restructuring, cleansing, format revision, transformation, derivation, aggregation, integration, filtering, splitting, summarization, correction, reporting and modification.

19. A non-transitory computer-readable recording medium storing instructions for executing a method for distribution management, comprising the steps of:
receiving input data to a data loader;
processing the input data using a validation assessment to produce validated data;
associating the validated data with a plurality of predefined data fields to create a plurality of data structures;
creating an aggregated data structure from the plurality of data structures based on at least one predefined data field; and
providing access, via at least one access point, to the aggregated data structure, wherein the at least one access point is accessible to a first user.

20. A data loader for a distribution management system, the data loader being configured to:
receive input data;
process the input data using a validation assessment to produce validated data;
associate the validated data with a plurality of predefined data fields to create a plurality of data structures;
transmit the plurality of data structures to an aggregation module, the aggregation module configured to create an aggregated data structure from the plurality of data structures based on at least one predefined data field.
